(19) United States
(12) Patent Application Publication
(10) Pub. No.: US 2026/0252998 A1
(43) Pub. Date: Aug. 27, 2026

(54) JOURNEY MAP SYSTEM

(71) Applicant: Adobe Inc., San Jose, CA (US)

(72) Inventors: Jun He, Fremont, CA (US); Yantao Zheng, Cupertino, CA (US); Xinyue Liu, San Jose, CA (US); Tingting Xu, Sunnyvale, CA (US); Sonali Surange, San Rafael, CA (US); Katrina Shanti Patel, Danville, CA (US)

(73) Assignee: Adobe Inc., San Jose, CA (US)

(21) Appl. No.: 19/065,584

(22) Filed: Feb. 27, 2025

(51) Int. Cl. G06Q 10/0633; G06Q 10/0639

(52) U.S. Cl. CPC G06Q 10/0633; G06Q 10/06393

(57) ABSTRACT

A journey map system is configured to employ a machine-learning model to assign category tags to historical journey maps. The journey map system then generates clusters based on similarities between these journey maps. Effectiveness of these clusters in performing an operation is determined by the journey map system using performance indicator data. The journey map system identifies representative journey maps based on the performance indicator data, the clusters, and the category tags. Finally, the journey map system generates insights using a language model implemented with machine learning.

### BACKGROUND

Journey maps are usable in a variety of contexts to describe successive actions performed by a variety of entities. A journey map, for instance, may be configured as a graph using nodes and connections between the nodes to describe a sequence of operations performed by a hardware device, actions undertaken by a user, and so forth.

In real-world scenarios, however, a multitude of journey maps are tasked with describing a significant number of these actions for thousands and even hundreds of millions of entities and therefore involve a vast amount of data. Journey maps, for instance, may be applied to millions of entities, thereby causing generation of vast amounts of data. Thus, managing and analyzing hundreds or thousands of journey map designs presents significant computational and technical challenges. Accordingly, computational functionalities that are implemented to leverage these journey maps are confronted with this vast amount of data and corresponding consumption of significant amounts of computational and power resources, delays in producing a result, as well as other inefficiencies that hinder operational performance.

### SUMMARY

A journey map system is described supportive of a variety of technical advantages that address conventional technical challenges involved in processing vast amounts of data. By employing machine learning for category tagging and graph clustering techniques, the journey map system efficiently identifies representative journey maps from large datasets, reducing computational overhead and storage concerns. The use of a language model to generate insights from these representative maps further streamlines data processing, allowing for rapid analysis without repeatedly processing an entire historical dataset. This approach significantly reduces computational resource consumption and improves response times when generating insights or recommendations. Additionally, the journey map system supports an ability to automatically extract and index metadata thereby enhancing search capabilities and efficient retrieval of relevant journey information.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ journey map systems and techniques as described herein FIG. 2 depicts a system in an example implementation showing operation of the metadata extraction module, journey map analysis system, and insight generation system of a journey map system of FIG. 1 in greater detail.

FIG. 3 depicts a system in an example implementation showing operation of a journey graph tagging system of FIG. 2 in greater detail as generating tagged journey map categories based on historical journey maps.

FIG. 4 depicts a system in an example implementation showing operation of a journey miner module of FIG. 2 in greater detail as employing clustering, pattern mining, and journey selection in identification of the representative journey maps.

FIG. 5 depicts an example of historical journey maps clustering.

FIG. 6 depicts an example implementation of a representative journey map and associated insights.

FIG. 7 depicts an example implementation of a representative journey map and associated insights.

FIG. 8 depicts an example implementation of a representative journey map and associated insights.

FIG. 9 depicts an example implementation of a representative journey map and associated insights.

FIG. 10 is a flow diagram depicting an algorithm as a step-by-step procedure in an example implementation of operations performable for accomplishing a result of representative journey map identification based on clustering and category tagging.

FIG. 11 illustrates an example system including various components of an example device that can be implemented as any type of computing device as described and/or utilize with reference to FIGS. 1-10 to implement embodiments of the techniques described herein.

### DETAILED DESCRIPTION

### Overview

Journey maps are configurable to describe sequences of operations performable in a variety of contexts. In a real-world scenarios involving a service provider system (e.g., an online platform of digital services), for instance, journey maps are usable to describe operation of computational resources used to implement digital services of the service provider systems, sequences of digital content provided by the digital services (e.g., webpages, UIs), user actions undertaken with respect to the digital content and corresponding results of that interaction (e.g., conversion), and so forth.

As a result, a vast amount of data is typically generated in these real-world scenarios in order to generate journey maps that describe these operational sequences for thousands and even hundreds of millions of entities. This vast amount of data, therefore, presents a variety of technical challenges in use of this data. Delays, for instance, are typically observed in obtaining a result using these functionalities. Further, processing this vast amount of data also consumes corresponding amounts of computational resources, electrical power in supporting these resources, and so forth.

Accordingly, to address these and other technical challenges a journey map system is described that is configured to improve operational performance, reduce computational resource and power consumption as well as improve insights that may be gained based on journey maps. To do so, a journey map system is configured to implement journey category tagging, representative journey discovery, high-level journey mapping and insight generation, and support indexing and search.

The journey map system, for instance, is configurable to assign a plurality of category tags to a plurality of historical journey maps using a machine-learning model. The machine-learning model, for example, may be trained as a classifier to classify respective historical journey maps generated through monitored real world interactions into one or more respective categories, e.g., device termination, operational abandonment, successful task completion, and so forth.

The journey map system is also configurable to generate representative journey maps, and in this way reduce an amount of data involved in subsequent insight generation that would otherwise be involved in directly processing the historical journey maps. The journey map system, for instance, employs graph clustering and pattern mining techniques that are usable to identify representative journey graphs for each of the different categories, e.g., the categories used in the tagging process described above. As part of this, the journey map system is configurable to employ performance indicator data that quantifies exhibited suitability of a respective representative journey map on achieving a task, i.e., a desired outcome. The representative journey maps are then utilized as templates for developing insights into past operation as well as further operations.

The journey map system, for example, is configurable to employ a language model (e.g., a large language model) that employs machine learning to generate insights. The journey map system, for instance, is configurable to generate the insights using the representative journey maps independent of the plurality of the historical journey maps, although instances are also contemplated that include use of the historical journey maps. In a first example, the language model is employed to translate the representative journey maps into text-based summaries as insights into the operations performed in plain language that is readily understood by a human being.

The language module is also configurable to support a variety of other insights, examples of which include new journey map generation, identification of key touchpoints, operational behavior insights, performance, segments, and so forth. In this way, processing and power resource efficiency is increased through the use of the representative journey maps as well as increased insight richness that is not readily available to a human being through processing of the representative journey maps using a language model. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Journey Map Environment

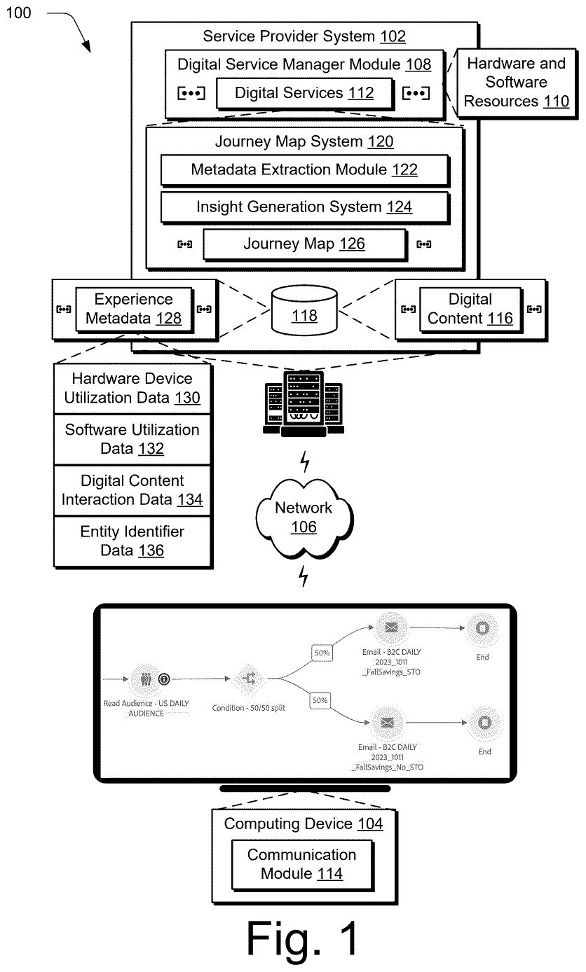

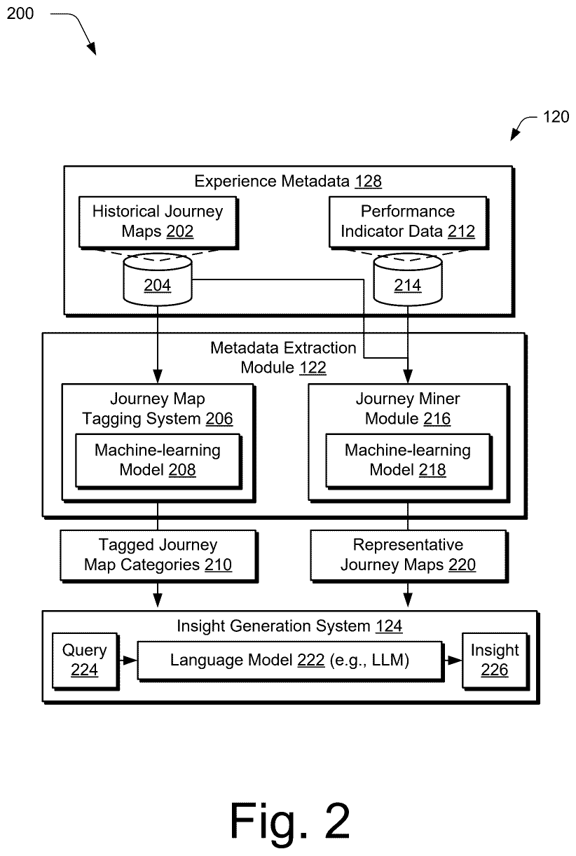

FIG. 1 is an illustration of a digital medium environment 100 in an example implementation that is operable to employ journey map systems and techniques as described herein. The illustrated environment 100 includes a service provider system 102 and a computing device 104 that are communicatively coupled, one to another, via a network 106. Computing devices are configurable in a variety of ways.

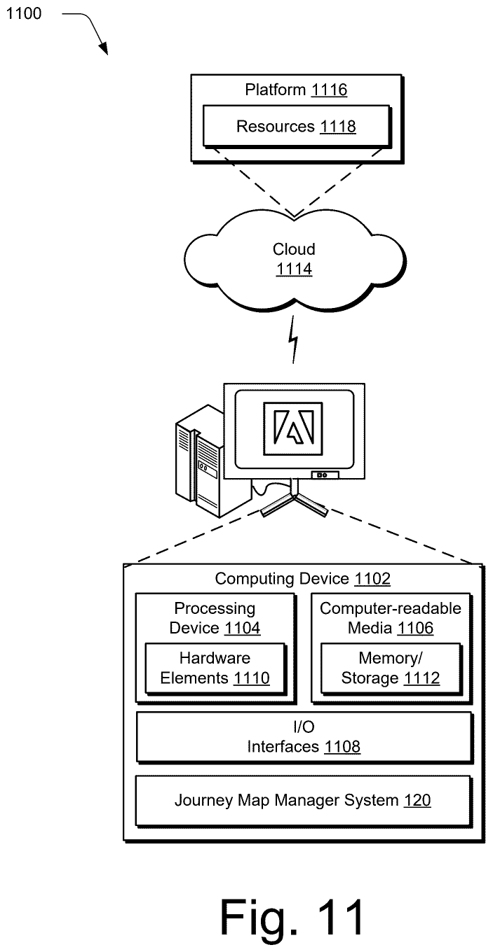

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 11.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement provision of a plurality of digital content 116, which is illustrated as maintained in a storage device 118. The digital content 116 may take a variety of forms, such as digital images, digital documents, webpages, pages of a user interface, digital audio, digital media, and so forth.

The service provider system 102 also includes a journey map system 120 that is configurable to leverage journey maps 126 to describe sequences of operations performed in a variety of contexts. The journey maps 126, for instance, are configurable to describe sequences of interaction by entities (e.g., the computing device 104) with the plurality of digital content 116 as provided by the service provider system 102. The journey maps 126 are also configurable to describe software execution as well as operation of hardware devices in providing this digital content, e.g., processing devices, servers, computer-readable storage media, network connection devices, and so forth.

The journey map system 120 is configurable in a variety of ways to support a variety of functionalities related to journey maps. Illustrated examples of this functionality include a metadata extraction module 122 and an insight generation system 124. The journey map system 120, for instance, is configurable to leverage experience metadata 128 that describes a variety of aspects that may be described by a journey map 126. Illustrated examples of the experience metadata 128 include hardware device utilization data 130, software utilization data 132, digital content interaction data 134, entity identifier data 136, and so forth.

The journey map system 120, through use of the metadata extraction module 122 and insight generation system 124 supports an automated system for journey graph metadata extraction and high-level mapping across journey maps 126. The journey map system 120, for instance, is configurable to utilize a combination of weak supervision, machine learning, graph clusters, and language models to efficiently tag, discover, map and provide insights from journey maps. Additionally, the extracted metadata enables robust indexing, search, and recommendation functionalities.

The journey map system 120 supports scalability across platforms implemented by different service provider system 102, and as such is capable of processing journey maps from a variety of sources. This versatility makes the journey map system 120 using journey optimizer solutions. Secondly, the automation capabilities shown in the metadata extraction module 122 significantly reduce manual effort in tagging, representative journey discovery, and map generation.

Further, the data-driven nature of the journey map system 120 is implemented through a machine learning approach used for journey categorization by the metadata extraction module 122. Additionally, large language model (LLM) integration is usable to ensure objective, data-backed recommendations by the insight generation system 124. The ability of the journey map system 120 to identify representative journeys provides proven templates for future campaigns, potentially improving engagement and conversion rates in a digital marketing scenario.

In this way, the journey map system 120 supports a variety of usage scenarios. The journey map system 120, for instance, is configurable to leverage the experience metadata 128 for performance-based journey search and recommendation. The journey map system 120 may also identify high-performing journey templates from historical, which can be adapted for future campaigns. In this way, the journey map system 120 addresses the technical challenges of vast amounts of data usable to implement journey maps, further discussion of which is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Journey Map Analysis

The following discussion describes journey map analysis techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

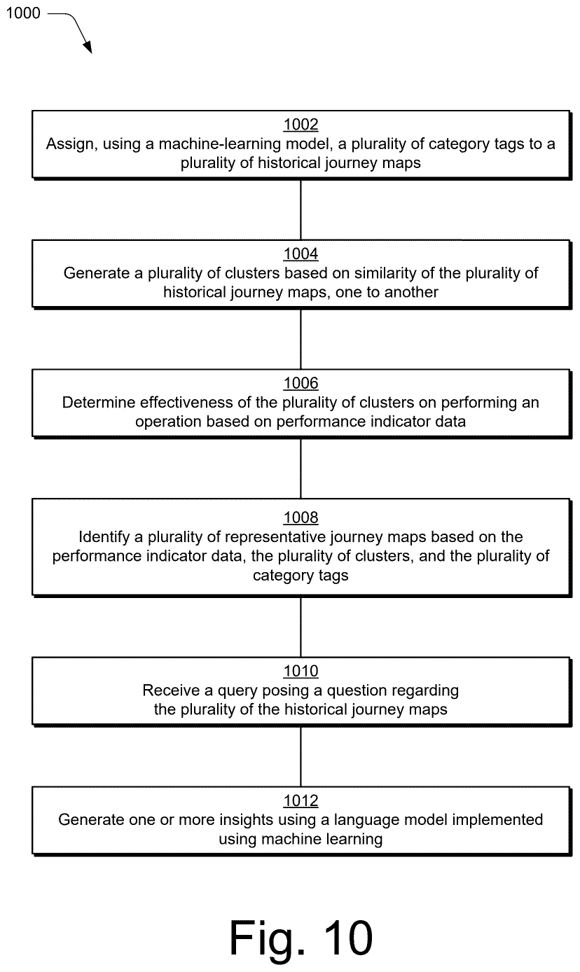

FIG. 2 depicts a system 200 in an example implementation showing operation of the metadata extraction module 122 and insight generation system 124 of the journey map system 120 of FIG. 1 in greater detail. FIG. 10 is a flow diagram depicting an algorithm 1000 as a step-by-step procedure in an example implementation of operations performable for accomplishing a result of representative journey map identification based on clustering and category tagging. In portions of the following discussion, reference is made in parallel to FIGS. 2 and 10.

The journey map system 120 is configurable to leverage a diverse set of data sources to generate comprehensive and accuracy journey maps. The data sources provide a rich foundation for analysis and insight generation by the journey map analysis system 124. In the illustrated example of FIG. 1, the experience metadata 128 includes historical journey maps 202 as stored in a storage device. A journey map tagging system 206 then employs a machine-learning model 208 to assign a plurality of category tags to the plurality of historical journey maps, illustrated as tagged journey map categories 210.

The historical journey maps 202 are utilized to capture a structure and flow of journeys undertaken by respective entities. The historical journey maps 202 are configurable in a variety of ways, examples of which include a JavaScript Object Notation (JSON) format that utilizes a graph formed through nodes connected, one to another, by respective edges.

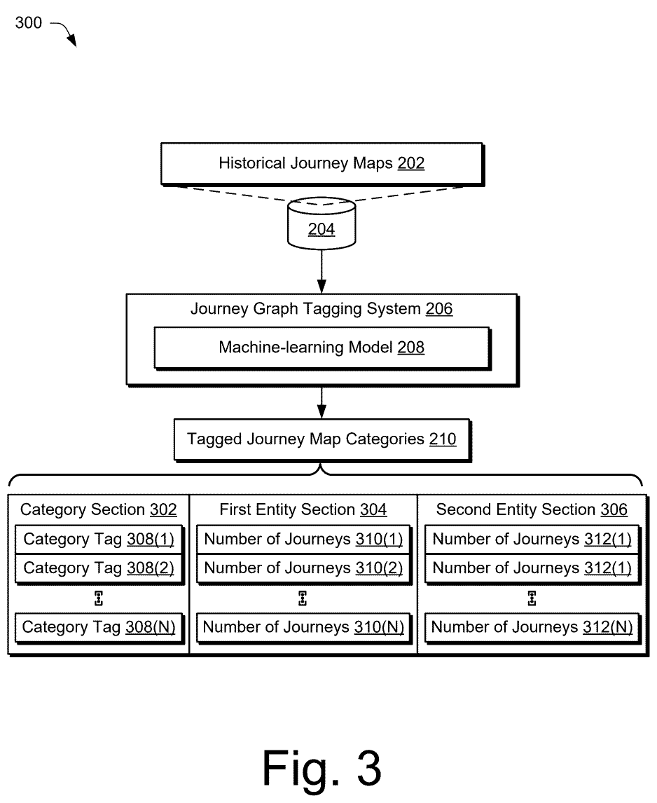

FIG. 3 depicts a system 300 in an example implementation showing operation of the journey graph tagging system 206 of FIG. 2 in greater detail as generating tagged journey map categories 210 based on historical journey maps 202. The journey graph tagging system 206 is configured to assign, using a machine-learning model 208, a plurality of category tags to a plurality of historical journey maps (block 1002), respectively.

Journey graph tagging system 206 utilizes a machine-learning model 208 to automatically assign category tags to the historical journey maps 202. The journey graph tagging system 206, for instance, analyzes various textual and structural components of the historical journey maps 202, including journey names, descriptions, graph nodes and edges, segment conditions, message content, and delivery channels. The journey graph tagging system 206 then produces a set of meaningful category tags for each journey, which helps in organizing and categorizing journeys for better searchability, recommendations, and strategic insights as part of training the machine-learning model 208.

The historical journey maps 202, for instance, are configurable in a Javascript Object Notation (JSO) format, which may contain a journey name, description, graph node and edge information, condition expressions, and message content. The journey graph tagging system 206, through use of the machine-learning model 208 once trained, is then configured to output tagged journey map categories 210. In the illustrated example, the tagged journey map categories 210 includes a category section 302 (e.g., identifying respective categories), a first entity section 304, and a second entity section 306. The category section 302 includes category tags 308(1), 308(2), . . . , 308(N). The first entity section 304 indicates a number of journeys 310(1), 310(2), . . . , 310(N) for the respective category tags 308(1), 308(2), . . . , 308(N) associated with a first entity. The second entity section 306 indicates a number of journeys 312(1), 312(2), . . . , 312(N) for the respective category tags 308(1), 308(2), . . . , 308(N) associated with a second entity.

In one or more implementation, the journey graph tagging system 206 employs a weak supervision approach to enable efficient and scalable category tagging. Weak supervision involves using imperfect, noisy, or limited sources of information to train machine-learning model 208. In this case, the journey graph tagging system 206 defines labeling rules and heuristics based on the journey characteristics.

For each predefined category, the journey graph tagging system 206 develops a set of labeling functions, which are rules or patterns that capture the essence of that category. For instance, a “cart abandonment” journey may involve users who leave items in their shopping cart without completing the purchase, while a “welcome” journey might be triggered by a new customer signing up. The weak supervision method aggregates these labeling functions to create a labeled dataset, even with incomplete or noisy data. This dataset is then used to train machine-learning model 208 as a multi-label classification model that learns to predict category tags 308(1)-308(N) for each of the plurality of historical journey maps 202. Journey maps may be associated with multiple categories. For instance, a journey could be tagged as both “promotional” and “newsletter” if a historical journey map 202 fits the criteria for both categories.

Returning again to FIG. 2, the experience metadata 128 also includes performance indicator data 212 accessed via a storage device 214. The performance indicator data 212, for instance, is configurable to describe key performance indicators involving device operation, examples of which include device compliance rate which measures a percentage of devices that comply with security policies and regulations, security incident rate which tracks a number of security incidents or breaches involving devices over a specific period, average response time which describes an average time taken to respond to and resolve device-related issues, user satisfaction score which gauges user satisfaction with device performance and support services, device enrollment rate which measures a rate at which new devices are enrolled and configured for use, application performance metrics which monitor application performance including load times and error rates, and so forth. Other examples include measurements of entity interactions with plurality of digital content 116, e.g., open rates indicating effectiveness of initial engagement, click-through rates measuring an appeal of content and calls-to-action, conversion, rates, multi-channel information, message content, and so forth.

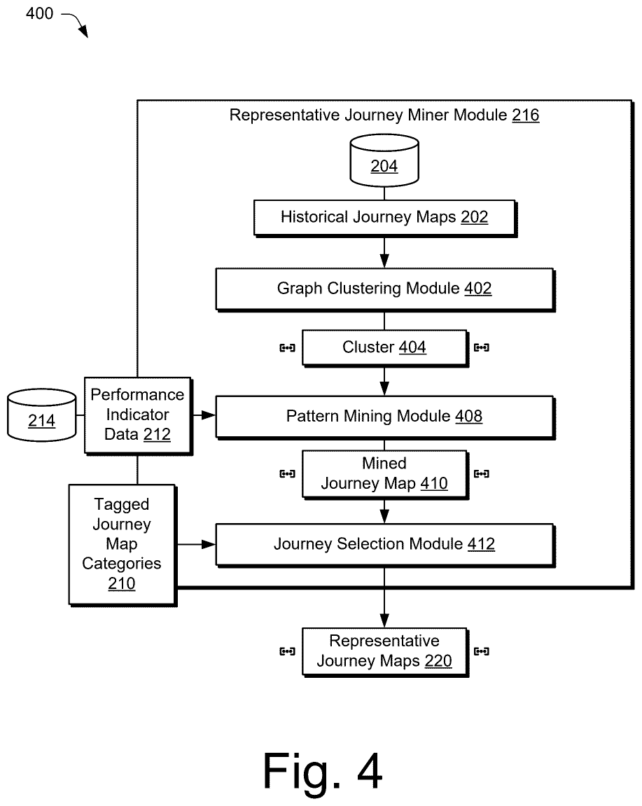

The performance indicator data 212 and the historical journey maps 202 are processed by a journey miner module 216 in the illustrated example. The journey miner module 216 employs a machine-learning model 218 to generate representative journey maps 220 as representative of the historical journey maps 202 based on the performance indicator data 212 as further described in relation to FIG. 4.

The journey miner module 216 is configurable to automatically identify the representative journey maps 220 as “most representative” of one or more of the historical journey maps 202, e.g., within different categories. As a result, the journey miner module 216 provides insights into effective journey maps, enabling the replication of successful strategies and enhancement of desired outcomes. By automating the identification of recurring and high-performing representative journey maps 220, the journey miner module 216 streamlines optimization strategies and improves overall effectiveness.

The journey miner module 216, in one or more examples, receives as inputs the historical journey maps 202 that capture a sequence of touchpoints and interactions entities have with the plurality of digital content 116. Additionally, the inputs incorporate performance indicator data 212 that may include journey performance metrics, including key performance indicators (KPIs) such as conversion rates and engagement metrics, which evaluate the effectiveness of various historical journey maps 202. These inputs form the foundation of the journey miner module 216 for the analysis and selection of the representative journey maps 220.

The output of this process, for instance, includes the “most representative” journey maps for each category. These representative journey maps 220 are selected based on recurrence and performance, and as such are operable as valuable templates for creating successful journey maps in future campaigns. By providing the representative journey maps 220, the journey miner module 216 supports insights into strategies and that are adaptable to target desired outcomes, e.g., potentially leading to improved engagement and conversion rates in subsequent initiatives.

FIG. 4 depicts a system 400 in an example implementation showing operation of the journey miner module 216 of FIG. 2 in greater detail as employing clustering, pattern mining, and journey selection in identification of the representative journey maps 220. The system 400 includes a journey miner module 216 of FIG. 2 that is configurable to process historical journey maps 202 stored in storage device 204.

The historical journey maps 202 are input to a graph clustering module 402, which generates clusters 404 based on similarities between the historical journey maps 202 (block 1004), one to another. The graph clustering module 402 uses graph clustering algorithms to group the historical journey maps 202 into distinct clusters 404, analyzing both the structure and nodes within the historical journey maps 202 to identify similarities. Each cluster 404 represents a set of historical journey maps 202 with common patterns and interactions.

The pattern mining module 408 processes the clusters 404 along with performance indicator data 212 stored in storage device 214 as a way to determine effectiveness of the plurality of clusters on performing an operation based on the performance indicator data 212 (block 1006). The pattern mining module 408, for instance, applies graph pattern mining techniques to identify the most representative journeys within each cluster 404 to identify the mined journey maps 410. This process is configurable with a focus on discovering recurring substructures and patterns in the historical journey maps 202, particularly those associated with high-performance metrics such as customer engagement or conversion rates as defined by the performance indicator data 212. The pattern mining module 408 generates mined journey maps 410 based on this analysis, selecting the most representative journeys based on both frequency of occurrence and performance.

The journey selection module 412 then processes the mined journey maps 410 along with tagged journey map categories 210 to output the representative journey maps 220. To do so, the journey selection module 412 identifies the plurality of representative journey maps 220 from the mined journey maps 410 output by the pattern mining module 408 based on the performance indicator data 212, the plurality of clusters 404, and a plurality of category tags (block 1008), e.g., depicted as the tagged journey map categories 210 in FIG. 4.

For each category, for example, the journey selection module 412 identifies a dominant cluster, which contains the most relevant journey maps for that category. From this cluster, the top mined journey map 410 is selected as the final archetype for that category, i.e., as the representative journey maps 220. As a result, the representative journey maps 220 represent the processed and analyzed journey information, including clustered journey graphs, per-cluster representative journey graphs, and per-category dominant cluster representative journey graphs. These outputs provide insights into journey patterns and high-performing journey structures for different categories with increased storage efficiency, i.e., consumes less memory resources of an associated computing device and as such increased computational efficiency. In this way, the journey miner module 216 supports a variety of functionalities that improve operational performance. The journey miner module 216, for instance, categorizes the historical journey maps 202 into distinct clusters based on structural and node similarities, with each cluster representing a unique grouping of journey maps sharing common characteristics and patterns.

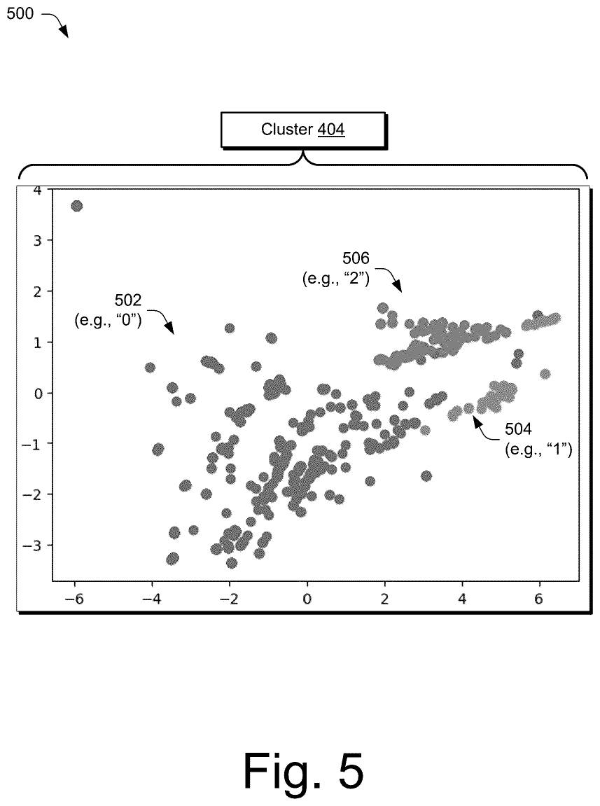

FIG. 5 depicts an example 500 of historical journey maps clustering. Within each cluster, the journey miner module 216 identifies and ranks the candidate journey maps 410 based on performance metrics in order to select the representative journey maps 220. The illustrated example 500 depicts results of applying graph clustering to 1,263 journeys for an entity for “zero” 502, “first” 504, and “secondary” 506 clusters as indicating distinct patterns in the historical journey maps 202.

Returning again to FIG. 2, the representative journey maps 220 along with the tagged journey map categories 210 are then usable by an insight generation system 124 to support increased access and computational efficiency in obtaining insights based on the historical journey maps 202 and the performance indicator data 212. The insight generation system 124, for instance, employs a language model 222 (e.g., a large language model (LLM)) that is configured to receive a query 224 posing a question regarding the plurality of historical journey maps 202 (block 1010) and generate one or more insights 226 (block 1012). The generating, for instance, may be performed by processing a prompt (e.g., that includes the query 224) based on the plurality of representative journey maps 220.

The insight generation system 124 addresses scaling and bias challenges associated with manual journey map creation by leveraging a large language model 222 to automate high-level journey map generation in this example. The insight generation system 124 also accelerates map and insight production through automation while improving accuracy through direct use of journey graph data. These input representative journey maps 220 provide a detailed sequence of paths through various touchpoints as nodes and edges. The insight generation system 124 then translates these representative journey maps 220 into user-friendly high-level journey maps using the large language model 222, enabling a comprehensive understanding of behavior patterns and strategy effectiveness by focusing on key actions and events from the representative journey maps 220.

The insight generation system 124 is also configurable to generate supplementary insights 226, e.g., attributes such as summaries, target audience information, themes, path-level summaries, and so forth. As a result, the one or more insights 226 support a broader perspective on complex journey maps, offering a comprehensive view of the journey. Although inputs as the representative journey maps 220 are shown, the insight generation system 124 may also process various inputs including text, briefs, graph/journey images, and so forth.

To do so, the insight generation system 124 is configurable through use of the large language model 222 to implement an insight generation pipeline. To begin in this example, the insight generation system 124 receives as an input the representative journey maps 220 as a journey graph JSON, which represents interactions as nodes and edges. The insight generation system 124 then prunes and preprocesses this data, formatting nodes and edges into a sequential journey and removing low-value elements. This pruned data is then converted into linear journey stages described in natural language. The insight generation system 124 proceeds to categorize these stages as touchpoints, events, or personas, consolidating the stages based on sequential node logic for a concise representation.

The insight generation system 124 then employs the large language model 222 to personalize and rephrase the consolidated journey map nodes from a particular point of view, e.g., of a user that is to read the text. This step ensures that the generated one or more insights 226 is tailored to an intended audience and presented in a natural and readily understandable format. The insight generation system 124, for instance, is configurable to produce a map summary that provides a concise overview of the representative journey maps 220, emphasizing key interactions and outcomes. Additionally, the insight generation system 124 is configurable to perform a target audience identification analysis, examining the personas involved in the journey map. This analysis yields insights into entity demographics, behaviors, and potential motivations, providing a comprehensive understanding of the journey's participants and corresponding characteristics.

As a result, the insight generation system 124 is configurable to automatically produce simplified, high-level representations of complex journey maps. By condensing detailed sequence data, the insight generation system 124 creates clear, user-friendly journey maps that highlight key stages such as touchpoints, events, and personas. This functionality provides an easily digestible overview of journeys, enabling quick understanding of how entities interact with an organization or product across various touchpoints.

Additionally, the insight generation system 124 is configurable to generate concise summaries for each journey map, emphasizing operations, milestones, and outcomes. These summaries, as text, are automatically created based on the journey map data, utilizing the large language model 222 to process and interpret the information. By offering a snapshot of behavior patterns and journey performance, the insight generation system 124 facilitates easier identification of key moments or potential gaps in the journey. This accelerates decision-making processes and aids in improving engagement strategies by providing rapid, data-driven insights.

The insight generation system 124 is also configurable to perform a comprehensive analysis of personas and segments involved in the journey. By leveraging the large language model 222, the insight generation system 124 identifies key demographics, behaviors, and potential motivations driving user actions throughout the journey. This deep analysis provides an in-depth understanding of a target audience, supporting precise segmentation and personalization strategies.

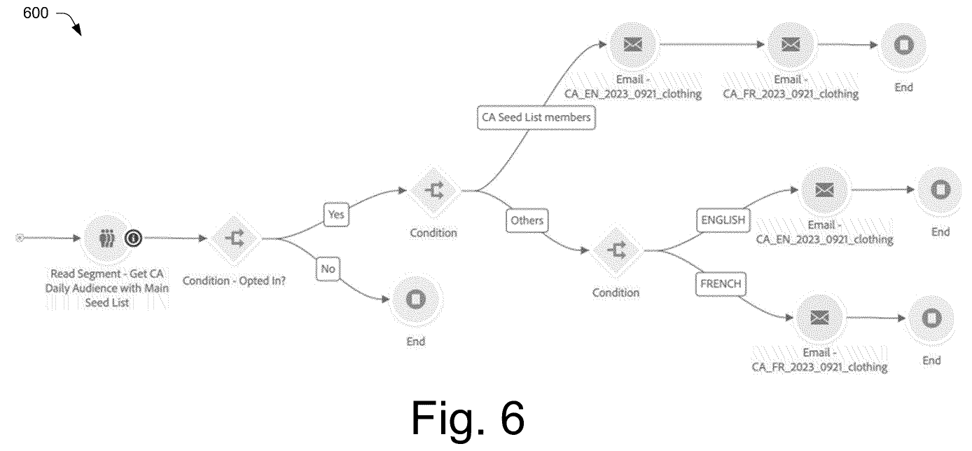

FIG. 6 depicts an example implementation 600 of a representative journey map 220. The representative journey map 220 begins with a “Read Segment” node labeled “Get CA Daily Audience from Seed List,” indicating an initial step of audience selection. From there, the representative journey map 220 flows into a condition node checking for “Opted In” status to segment the audience based on their opt-in preferences.

The representative journey map 220 then branches into two parallel paths based on language preferences. One path is designated for the “English” audience, leading to an email delivery node with the subject line “CA_EN_2023_0921_clothing.” The other path is for the “French” audience, culminating in an email delivery node with the subject line “CA_FR_2023_0921_clothing.” Both paths terminate in “End” nodes, indicating an end of the representative journey map 220.

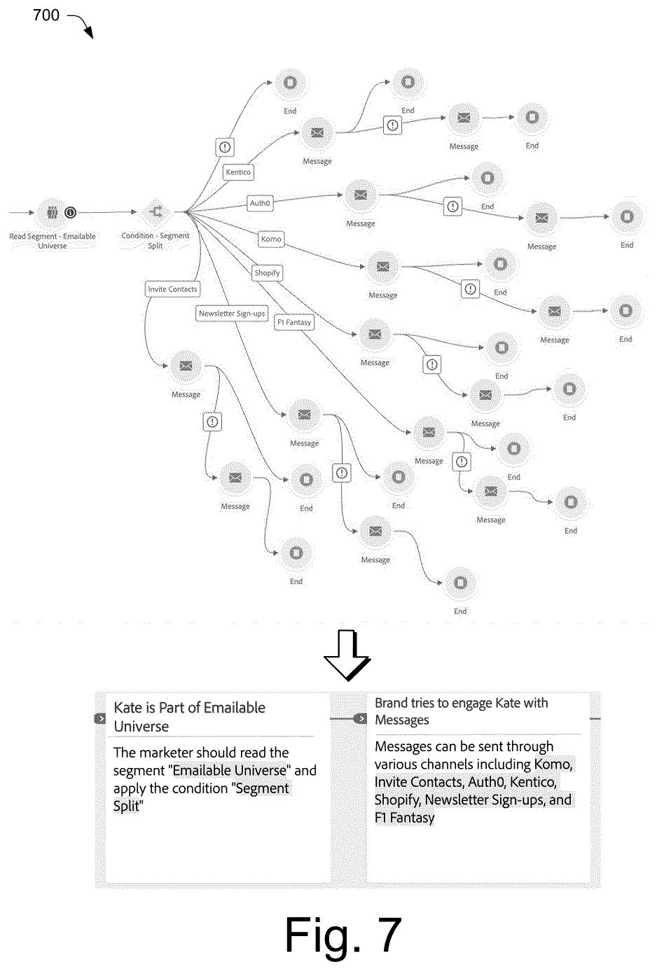

FIG. 7 depicts an example implementation 700 of a representative journey map 220 and associated insights. This implementation 700 presents a high-level journey map generated for Customer A's newsletter campaign. The journey map is structured as a simple two-node flow, connected by an arrow, representing the key stages of the journey. The first node, labeled “Kate is Part of Emailable Universe,” describes an initial segmentation step. The first node indicates that the insight generation system 124 is to read the “Emailable Universe” segment and apply a “Segment Split” condition. This step filters the audience based on specific criteria. The second node, “Brand tries to engage Kate with Messages,” outlines the various channels through which messages can be sent. These channels include “Komo,” “Invite Contacts,” “Auth0,” “Kentico,” “Shopify,” “Newsletter Sign-ups,” and “F1 Fantasy,” thereby demonstrating a multi-channel approach to customer engagement. Below the journey map, an insight is depicted as a summary that provides context for the playbook's focus on an email marketing campaign targeting newsletter subscribers, with a goal of engaging and converting customers through personalized messaging across different segments.

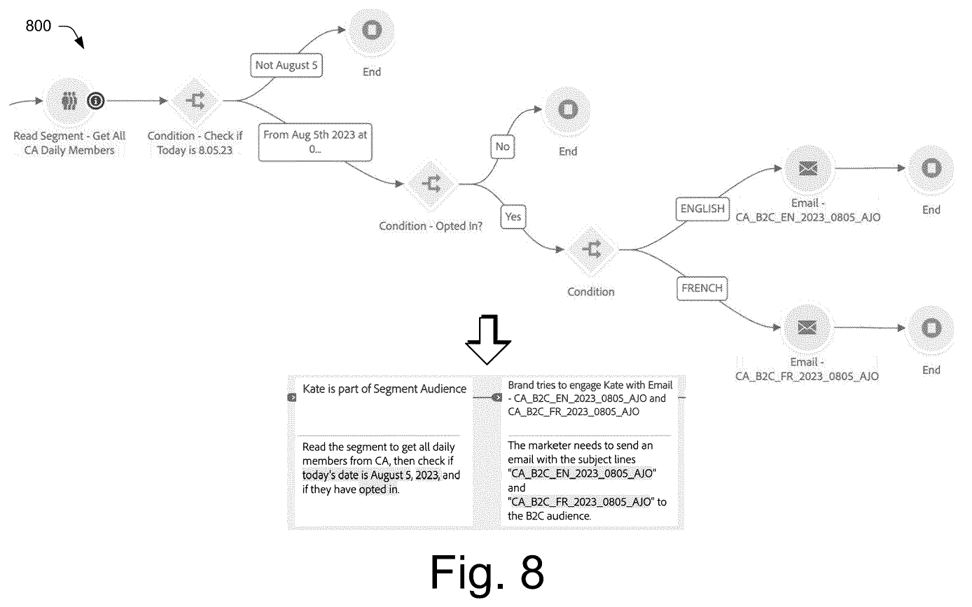

FIG. 8 depicts an example implementation 800 of a representative journey map 220 and associated insights. The representative journey map 220 begins with a “Read Segment” node labeled “Get CA Daily Audience from Seed List,” indicating the initial step of audience selection. This node flows into a condition check for “Opted In” status.

The representative journey maps 220 then branches into two parallel paths based on language preferences. One path is designated for the “English” audience, leading to an email delivery node with the subject line “CA_EN_2023_0921_clothing.” The other path is for the “French” audience, culminating in an email delivery node with the subject line “CA_FR_2023_0921_clothing.” Both paths terminate in “End” nodes. This structure illustrates how the system automatically identifies and represents a bilingual email marketing strategy within a single, representative journey graph for a newsletter campaign. The graph aligns with the summary provided, which emphasizes the campaign's focus on daily members who have opted in to receive marketing emails, with separate versions for English and French-speaking audiences.

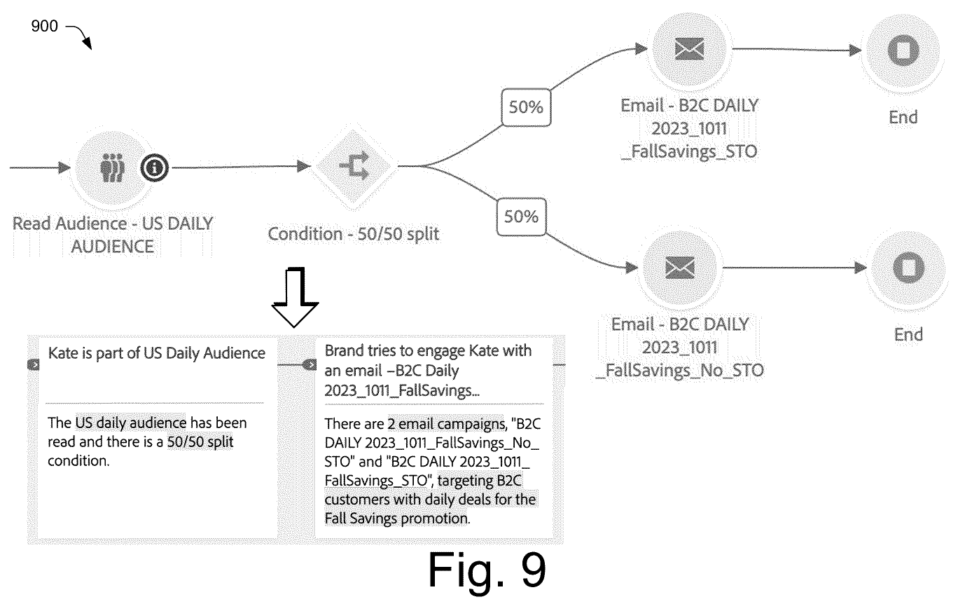

FIG. 9 depicts an example implementation 900 of a representative journey map 220 and associated insights. The representative journey maps 220 is structured as a two-node flow connected by a line, representing key stages of the journey map. The first node, titled “Kate is part of US Daily Audience,” describes an initial audience segmentation step. The first node, for instance, explains that the US daily audience has been read and a 50/50 split condition has been applied. This split indicates that the audience is evenly divided for the subsequent email campaign. The second node, labeled “Brand tries to engage Kate with an email B2C Daily 2023_1011_FallSavings . . . ,” outlines two distinct email campaigns: “B2C DAILY 2023_1011_FallSavings_No_STO” and “B2C DAILY 2023_1011_FallSavings_STO.” These campaigns target entities with daily deals for a Fall Savings promotion, aligning with the summary's description of a fall savings email campaign.

The journey map system 120 as described herein is configurable to extract and utilize journey graphs to enable more effective journey mapping. By implementing machine learning techniques, the system categorizes journey maps into respective categories and summaries that enhance searchability and indexing. This allows retrieval of relevant journey maps to support data-driven decisions that may improve campaign performance.

The journey map system 120 also identifies representative journey maps 220 within categories by employing graph clustering and pattern mining. This technique is usable to discern high-performing journey maps that have historically led to successful outcomes. The automated discovery of representative journey maps may save time and enhance the ability to learn from past results.

Additionally, integration of large language models for high-level journey mapping provides a tool for understanding entity behaviors. Automatically generating high-level maps from graph data, for instance, allows visualization of interactions and touchpoints in journey maps. Further, the insights produced may be used for journey map search and recommendations to enable targeting and personalization. Analyzing historical metrics with journey metadata allows optimization of strategies based on data. As a result, the journey map system 120 provides a framework for enhancing journey planning through metadata extraction and mapping. The use of machine learning and language models simplifies journey analysis and provides tools to optimize customer interactions.

### Example System and Device

FIG. 11 illustrates an example system generally at 1100 that includes an example computing device 1102 that is representative of one or more computing systems and/or devices that implement the various techniques described herein. This is illustrated through inclusion of the journey map system 120 of FIGS. 1 and 2. The computing device 1102 is configurable, for example, as a server of a service provider, a device associated with a client (e.g., a client device), an on-chip system, and/or any other suitable computing device or computing system.

The example computing device 1102 as illustrated includes a processing device 1104, one or more computer-readable media 1106, and one or more I/O interface 1108 that are communicatively coupled, one to another. Although not shown, the computing device 1102 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1104 is representative of functionality to perform one or more operations using hardware. Accordingly, the processing device 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112 that stores instructions that are executable to cause the processing device 1104 to perform operations. The computer-readable storage medium is configured for storing instructions that, responsive to execution by the processing device, causes the processing device to perform operations. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing device 1104. The instructions and/or functions are executable/operable by one or more articles of manufacture (for example, one or more computing devices 1102 and/or processing devices 1104) to implement techniques, modules, and examples described herein.

The techniques described herein are supported by various configurations of the computing device 1102 and are not limited to the specific examples of the techniques described herein. This functionality is also implementable all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

In implementations, the platform 1116 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
assigning, using a machine-learning model, a plurality of category tags to a plurality of historical journey maps;
generating, by a processing device, a plurality of clusters based on similarity of the plurality of historical journey maps, one to another;
determining, by the processing device, effectiveness of the plurality of clusters on performing an operation based on performance indicator data;
identifying, by the processing device, a plurality of representative journey maps based on the performance indicator data, the plurality of clusters, and the plurality of category tags;
receiving, by the processing device, a query posing a question regarding a plurality of historical maps;
identifying, by the processing device, a respective category of the plurality of historical maps posed in the question;
determining, by the processing device, an amount of recurring use of the plurality of historical maps;
selecting, by the processing device, a representative journey map from the plurality of representative journey maps based on the respective category and the determined amount of recurring use; and
generating, by the processing device, one or more insights using a language model implemented using machine learning, the generating performed by processing the query based on the representative journey map.

2. The method as described in claim 1, wherein the plurality of historical journey maps describe, respectively, performance of a plurality of operations as associated with a respective entity of a plurality of entities.

3. The method as described in claim 1, wherein the generating of the plurality of clusters is based on shared resource patterns, node similarities, or interaction sequences defined by respective said historical journey maps.

4. The method as described in claim 1, wherein the identifying is performed such that a respective said representative journey map describes characteristics and performance of respective said historical journey maps included in a respective said cluster.

5. The method as described in claim 1, wherein the identifying includes identifying a respective said cluster as corresponding to a respective said category tag and a respective said representative journey map is selected as representative of the respective said category tag.

6. The method as described in claim 1, wherein the performance indicator data includes one or more metrics indicating customer engagement with a historical map. cm 7. The method as described in claim 1, wherein the generating of the one or more insights by the language model is performed independent of the plurality of historical journey maps.

8. The method as described in claim 1, wherein the insight is a textual description as a summary of a map defined by a respective representative journey map of the plurality of representative journey maps.

9. The method as described in claim 1, wherein the plurality of category tags describe characteristics of a plurality of entities or the plurality of operations.

10. The method as described in claim 9, wherein the insight includes identification of an audience formed based on the plurality of entities as corresponding to a respective representative journey map of the plurality of representative journey maps.

11. A computing device comprising:
a processing device; and
a computer-readable storage medium storing instructions that, responsive to execution by the processing device, causes the processing device to perform operations including:
generating a plurality of clusters based on similarity of a plurality of historical maps, one to another;
determining effectiveness of the plurality of clusters on performing an operation based on performance indicator data;
identifying a plurality of representative journey maps based on the performance indicator data and the plurality of clusters;
receiving a query posing a question regarding a plurality of historical maps;
identifying a respective category of the plurality of historical maps posed in the question;
determining an amount of recurring use of the plurality of historical maps;
selecting a representative journey map from the plurality of representative journey maps based on the respective category and the determined amount of recurring use; and
generating one or more insights using a language model implemented using machine learning, the generating performed by processing the query based on the plurality of representative journey map.

12. The computing device as described in claim 11, wherein the generating of the plurality of clusters is based on shared resource patterns, node similarities, or interaction sequences defined by respective said historical journey maps.

13. The computing device as described in claim 11, wherein the identifying is performed such that a respective said representative journey map describes characteristics and performance of respective said historical journey maps included in a respective said cluster.

14. The computing device as described in claim 11, wherein the identifying includes identifying a respective said cluster as corresponding to a category tag and a respective representative journey map of the plurality of representative journey maps is selected as representative of the respective said category tag.

15. The computing device as described in claim 11, wherein the generating of the one or more insights by the language model is performed independent of the plurality of historical journey maps.

16. The computing device as described in claim 11, wherein the insight is a textual description as a summary of a map defined by a respective representative journey map of the plurality of representative journey maps.

17. The computing device as described in claim 11, wherein the operations further comprise assigning, using a machine-learning model, a plurality of category tags to a plurality of historical journey maps.

18. The computing device of claim 17, wherein the plurality of category tags describe characteristics of a plurality of entities or a plurality of operations and the insight includes identification of an audience formed based on the plurality of entities as corresponding to a respective representative journey map of the plurality of representative journey maps.

19. One or more computer-readable storage media storing instructions that, responsive to execution by a processing device, causes the processing device to perform operations comprising:
generating a plurality of clusters based on similarity of a plurality of historical maps, one to another;
determining effectiveness of the plurality of clusters on performing an operation based on performance indicator data;
identifying a plurality of representative journey maps based on the performance indicator data and the one or more clusters; and
receiving a query posing a question regarding the plurality of the historical maps;
identifying a respective category of the plurality of historical maps posed in the question;
determining an amount of recurring use of the plurality of historical maps;
selecting a representative journey map from the plurality of representative journey maps based on the respective category and the determined amount of recurring use; and
generating one or more insights using a language model implemented using machine learning, the generating performed by processing the query based on the representative journey map and independent of the plurality of historical maps.

20. The one or more computer-readable storage media as described in claim 19, wherein the insight includes identification of an audience formed based on a plurality of entities as corresponding to a respective representative journey map of the plurality of representative journey maps.
